(19) United States
(12) Patent Application Publication
(10) Pub. No.: US 2005/0107004 A1
(43) Pub. Date: May 19, 2005

(54) Method and apparatus for removing flash from a brick

(75) Inventors: David W. Brown, Toronto (CA); Ted Lyons, Acton (CA); Tim Elliott, Norval (CA)

Correspondence Address: BERESKIN AND PARR, 40 KING STREET WEST, BOX 401, TORONTO, ON, M5H 3Y2, CA

(73) Assignee: Brampton Brick Limited, Brampton (CA)

(21) Appl. No.: 10/705,904

(22) Filed: Nov. 13, 2003

(51) Int. Cl. B28D 1/00

(52) U.S. Cl. 451/38; 125/26

(57) ABSTRACT

A method and apparatus of removing flash from a brick is disclosed. The method includes the steps: a) moving a rod through the hole; and b) directing a pressurized fluid from the rod into the hole as the rod moves into and out of the hole. The apparatus includes a clamp and a tube which are connected to the frame. The clamp secures the brick. The tube is configured to move through the brick hole and retract back to its starting position while a pressurized fluid is directed into the hole from a distal end of the tube.

### FIELD OF THE INVENTION

The invention relates to flash removal, and in particular to a method and apparatus for removing core flash from bricks.

### BACKGROUND OF THE INVENTION

The process for mass producing bricks, which are typically made from clay, is well known. The bricks are extruded from clay, cut into the desired shape, and are then fired in a kiln. The extruded bricks (i.e. prior to being fired in a kiln) are referred to as “green bricks”.

Typically, a brick includes a number of holes, which are also known as “cores”. These holes are formed in the brick during the extrusion process for any number of reasons, such as reducing the weight of the brick. One type of hole frequently seen in bricks is a cylindrical hole through the entire thickness of the brick. Due to the imperfections of the wire cut process of cutting the green brick, flash is formed in the holes.

The formation of flash in brick holes is typically not a problem, since typical brick construction simply requires a brick to be laid on other bricks and fastened together by mortar to form structures.

However, in certain applications, specialized brick structures are required, where the holes of adjacent bricks are aligned, and fasteners are inserted through the holes of adjacent bricks. In these building applications, it is important that no flash be present in the holes, as the flash can block the fastener from entering the hole.

Accordingly, there is a need for an improved method and apparatus for removing flash from brick holes.

### SUMMARY OF THE INVENTION

According to a first aspect of the invention, a method of removing flash from a brick which defines a hole therein is provided. The method comprises: a) moving a rod through the hole; and b) directing a pressurized fluid from the rod into the hole.

Preferably, pressurized air is sprayed from the distal end of the rod while the rod moves into the hole and is retracted from the hole.

According to a second aspect of the invention, an apparatus from removing flash from a brick defining a hole therein. The apparatus comprises:
a) a frame;
b) a clamp connected to the frame, wherein the clamp is adapted to releasably secure the brick; and
c) a rod movably connected to the frame, the rod defining an axial channel therein;
wherein the rod is adapted to move through the hole and deliver a pressurized fluid from the axial channel into the hole.

Preferably, the rod is a tube configured to spray pressurized air from an open distal end thereof.

The preferred embodiment of the present invention provides a method and apparatus for automated removal of flash from bricks during their mass production.

### BRIEF DESCRIPTION OF THE DRAWINGS

In the accompanying drawings:

FIG. 1 is a perspective view of a preferred embodiment of the apparatus according to the present invention;

FIG. 2 is a perspective view of a portion of the preferred embodiment showing the brick table and rail mounts;

FIG. 3 is a perspective view of a portion of the preferred embodiment showing the main carriage;

FIG. 4 is a perspective view of a portion of the preferred embodiment showing the rear clamp carriage;

FIG. 5 is a perspective view of a portion of the preferred embodiment showing the side clamp assembly;

FIG. 6 is a perspective view of the preferred embodiment in the open position;

FIG. 7 is a perspective view of the preferred embodiment showing the rear clamp carriage in the closed position;

FIG. 8 is a perspective view of the preferred embodiment showing the side clamp assembly in the closed position; and

FIG. 9 is a perspective view of the preferred embodiment showing the main carriage in the closed position.

### DETAILED DESCRIPTION OF THE PREFERRED EMBODIMENT

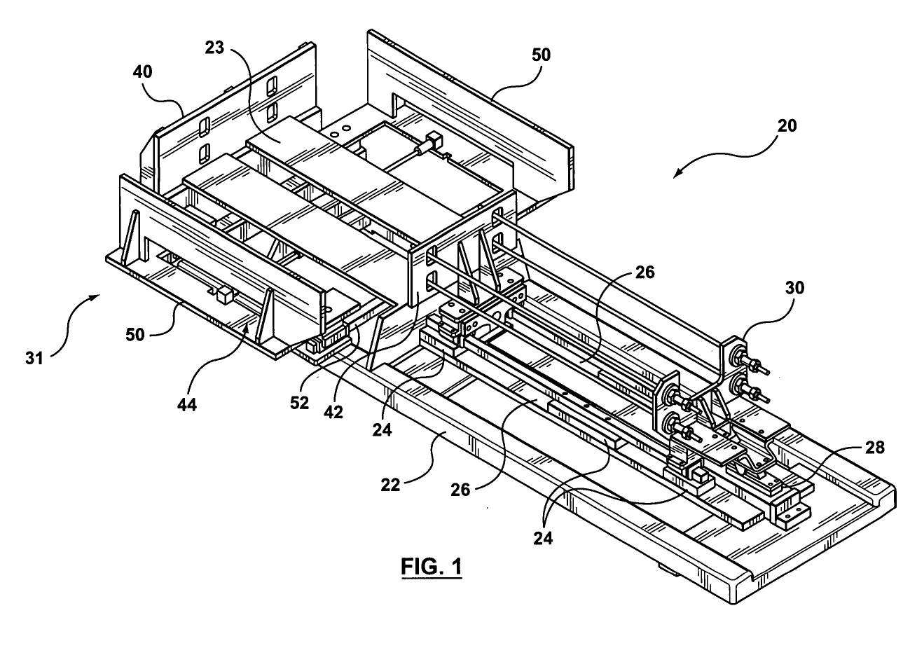

FIG. 1 shows an apparatus 20 for removing flash from brick holes.

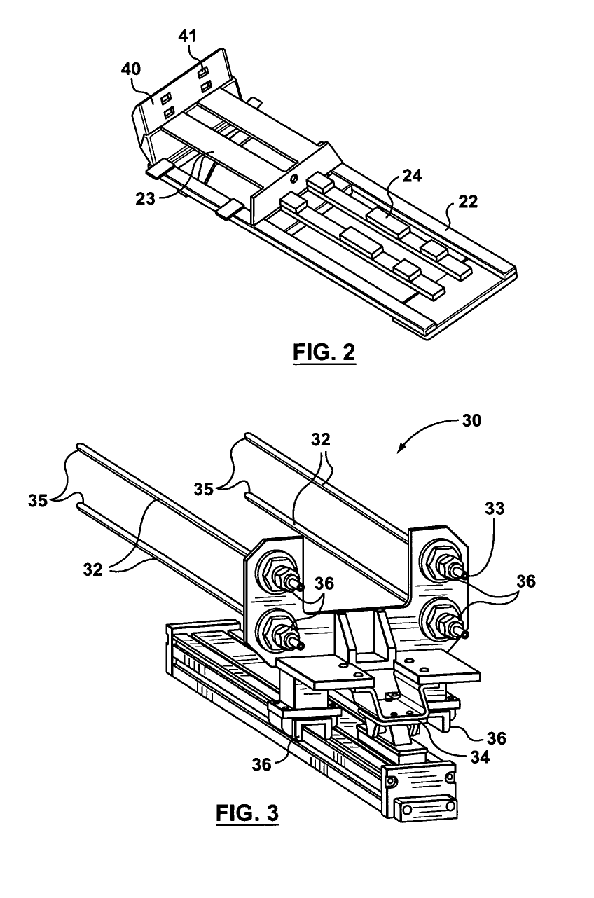

As best shown in FIG. 2, the apparatus 20 includes a generally planar frame 22. Rail mounts 24 are preferably welded to the frame 22. A brick table 23 is connected to the frame to support the bricks (not shown).

Referring again to FIG. 1, the rail mounts 24 support two slide rails 26. Three rail mounts 24 are provided for each slide rail 26. A rodless cylinder 28 is mounted by any suitable means (such as by bolts) to the frame 22 between the slide rails 26. The rodless cylinder 28 drives a main carriage 30. The rodless cylinder 28 is preferably a conventional slotted cylinder, such as RexMover™ Series277 which is commercially available from Rexroth™. A clamp 31 for securing the bricks (not shown) within the apparatus 20 is mounted at the other end of the frame 22.

Referring now to FIG. 3, the main carriage 30 includes four rods 32 connected to a bracket 34. Each rod 32 has an axial channel 33 defined therein. The axial channel 33 terminates at an open distal end 35. In the preferred embodiment which is best suited for bricks having cylindrical holes, the rods 32 are tubes having a diameter smaller than the diameter of the brick holes. However, the rods 32 may have any suitable shape, depending on the shape of the brick hole. In addition, any suitable number of rods 32 may be provided, depending on the number of holes in each brick and the configuration and number of bricks to be processed (as described in more detail below).

Continuing to refer to FIG. 3, an adjusting clamp 36 is provided for each rod 32 to precisely align each rod with the center of the brick core The rods 32 are connected to a supply of compressed air (not shown) in any conventional fashion. However, it will be understood by those skilled in the art that any other suitable pressurized gas which does not affect the integrity of the clay may be used.

Continuing to refer to FIGS. 1 and 3, the bracket 34 is connected to the rodless cylinder 28. Linear bearings 36 are secured to the bracket 34 and engage the slide rails 26.

Referring again to FIG. 1, the clamp 31 includes a front clamp plate 40 secured to the frame 22, a rear clamp carriage 42, and a side clamp assembly 44. The front clamp plate 40 includes four waste holes 41.

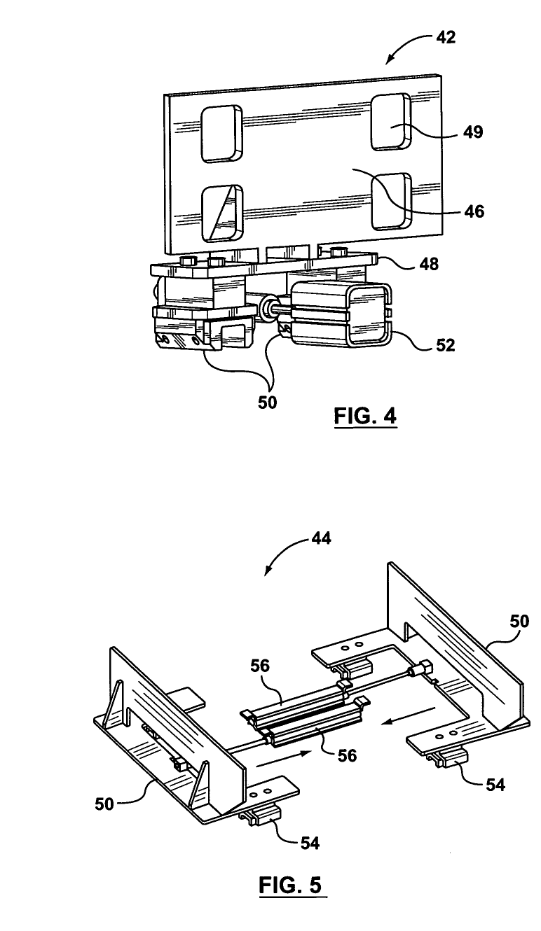

Referring now to FIG. 4, the rear clamp carriage 42 includes a rear clamp plate 46 connected to a rear clamp bracket 48. The rear clamp plate includes four openings 49. The rear clamp bracket 48 is mounted on the sliding rails 26 (shown in FIG. 1) by linear bearings 50. An air cylinder 52 is connected to the rear clamp bracket 48 to activate the rear clamp plate 46.

Referring to FIG. 5, the side clamp assembly 44 includes two side clamp plates 50. The slide clamp plates 50 are supported on transverse rails 52 (shown in FIG. 1) by linear bearings 54 connected to the slide clamp plates 50. The transverse rails 52 are connected to the frame 22. Each side clamp plate 50 is driven by a corresponding air-activated cylinder 56.

The operation of the present invention will now be described. FIG. 1 shows the apparatus 20 in the open position. The two side clamp plates 50 and the rear clamp plate 46 are retracted. The main carriage 30 is also retracted away from the brick table 23.

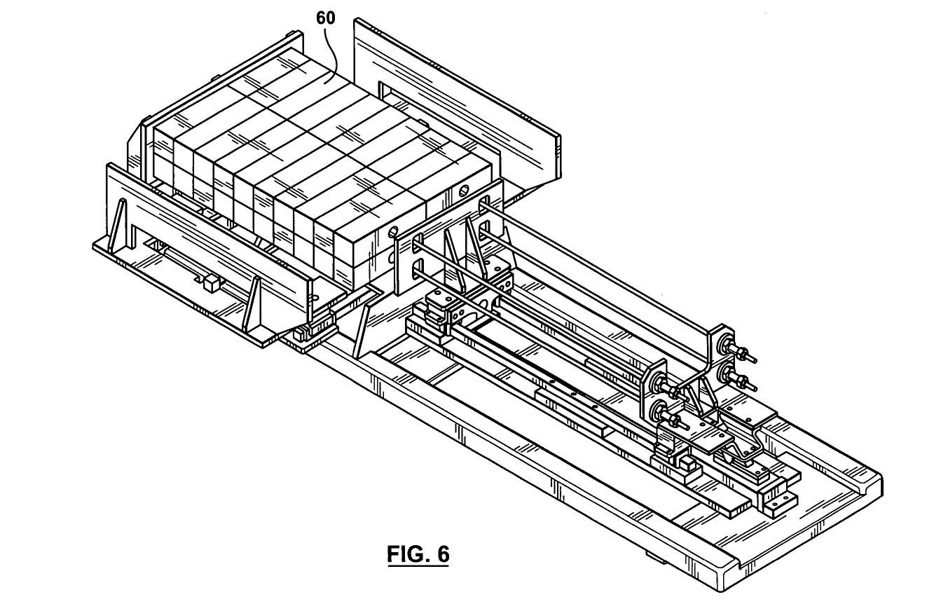

Referring to FIG. 6, a conventional programmable logic control or PLC (not shown) communicates with a robotic delivery system (also not shown) to instruct it to place a brick stack 60 the brick table 23 (best shown in FIG. 2). It will be understood by those skilled in the art that the PLC for a commercially available automated system for mass producing bricks from clay may be modified to operate the apparatus of the present invention. Alternatively, and independent PLC may be constructed in accordance with known techniques. Finally, manual operation of the apparatus, without a PLC, may be used for small batch requirements.

In the preferred embodiment, the brick stack 60 is configured such that it is two bricks in height and width, and ten bricks in length, with the brick holes being aligned to form a cylindrical channel. It will be understood by those skilled in the art that the brick stack 60 may include any suitable number of bricks in any suitable configuration depending on the configuration of the rods 32 in the apparatus 20. In addition, the brick stack 60 is composed of green bricks (i.e. extruded bricks which have not been fired in a kiln).

The robotic delivery system is part of the commercially available automated system for mass producing bricks from clay, and will not be further described. After delivering the brick stack 60, the delivery system retracts and signals to the PLC that it is clear of the apparatus 20.

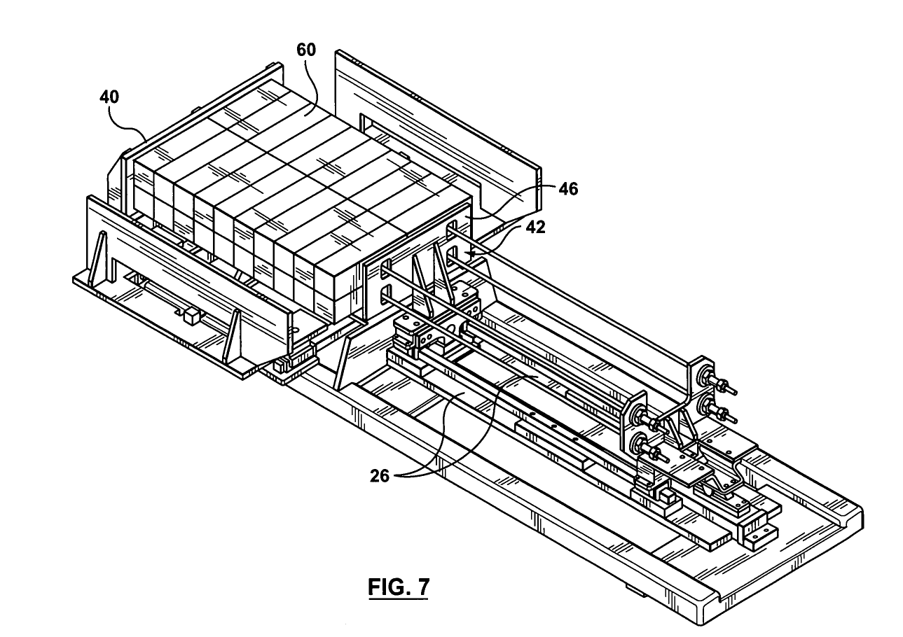

Referring now to FIG. 7, the PLC activates a first solenoid (not shown) which controls the rear clamp carriage 42, causing the rear clamp carriage 42 to move along the slide rails 26 toward the brick stack 60 until the brick stack 60 is clamped between the front clamp plate 40 and the rear clamp plate 46.

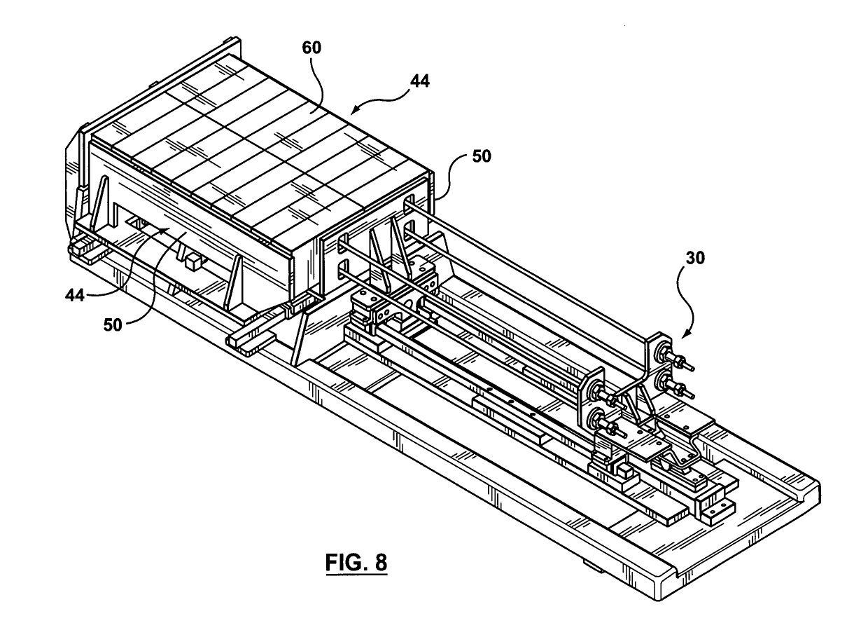

Referring to FIG. 8, a second solenoid (not shown) is activated to control the side clamp assembly 44, causing the side clamp plates 50 to slide toward the brick stack 60 along the transverse rails 52 (shown in FIG. 1). The side clamp plates 50 clamp the brick stack 60 in position for flash removal, such that the holes in the brick stack 60 are aligned with the openings 49 in the rear clamp plate 46.

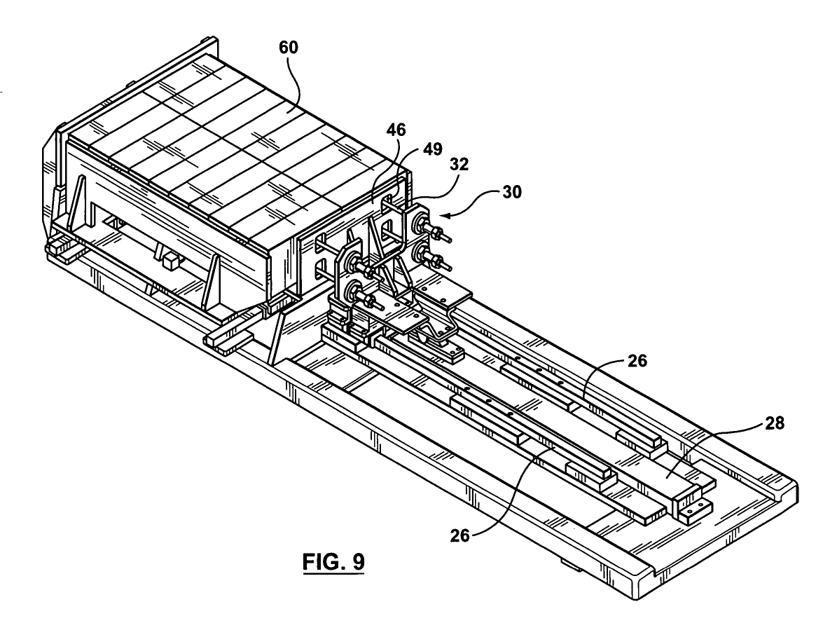

Referring to FIG. 9, the rodless cylinder 28 is activated by the PLC, driving the main carriage 30 along the slide rails 26 toward the brick stack 60. As the rods 32 move through the openings 49 in the rear clamp plate 46 and enter the holes in the brick stack 60, pressurized air is directed into the holes from the distal end 35 of the axial channels 33 (best shown in FIG. 3) in the rods 32. The rods 32 move through the holes in the brick stack 60 and then retract to their original position. During the entry and the retraction stroke, pressurized air is sprayed into the holes from the rods 32 to break off any flash which may have formed in the brick holes during the extrusion process. Any flash which is not removed by the force of the pressurized air, is punched out of the hole by physical contact with the rods 32.

Referring to FIGS. 1 and 2, the flash removed from the brick stack 60 is blown by the rods 32 through the brick stack 60 and out of the apparatus 20 through the waste holes 41 in the front clamp plate 40. The flash is blown into a duct (not shown) which channels the flash into a conveyor (not shown) running below the apparatus 20.

The pressurized air flow from the rods 32 is turned off when the rodless cylinder 28 driving the main carriage 30 has returned to its starting or “at rest” position, as shown in FIG. 8.

The side and rear clamp carriages 44, 42 are then retracted to the positions shown in FIGS. 7 and 6, respectively.

A reed switch (not shown) on the air cylinder 52 communicates to the PLC that the rear clamp carriage 42 has been retracted to the open position. The PLC then signals to the robotic delivery system that the brick stack 60 is to be removed. The robotic delivery removes the brick stack 60 and delivers a new brick stack for flash removal. The above process is then repeated.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A method of removing flash from a brick defining a hole therein, the method comprising:
a) moving a rod through the hole; and
b) directing a pressurized fluid from the rod into the hole.

2. The method of claim 1, further comprising clamping the brick.

3. The method of claim 2, further comprising aligning the hole with a longitudinal axis of the rod.

4. The method of claim 3, wherein the directing step comprises spraying the pressurized fluid from a distal end of the rod.

5. The method of claim 4, wherein the flow of the pressurized fluid into the hole is commenced about when the rod enters the hole.

6. The method of claim 5, further comprising retracting the rod out of the hole.

7. The method of claim 6, wherein the fluid is sprayed into the hole during the moving step and the retracting step.

8. The method of claim 7, wherein the pressurized fluid comprises pressurized air.

9. The method of claim 8, wherein the clamping step comprises restricting the longitudinal movement of the brick.

10. The method of claim 9, wherein the clamping step comprises restricting the transverse movement of the brick.

11. The method of claim 10, wherein the method comprises removing flash from a plurality of the bricks, wherein the hole of each of the plurality of bricks are aligned.

12. The method of claim 11, wherein a plurality of the rods are moved through the bricks, wherein each of the bricks defines a plurality of holes.

13. An apparatus from removing flash from a brick defining a hole therein, the apparatus comprising:
a) a frame;
b) a clamp connected to the frame, wherein the clamp is adapted to releasably secure the brick; and
c) a rod movably connected to the frame, the rod defining an axial channel therein;
wherein the rod is adapted to move through the hole and deliver a pressurized fluid from the axial channel into the hole.

14. The apparatus of claim 13, wherein the rod comprises an elongate tube defining an open distal end, the elongate tube being adapted to spray the pressurized fluid from the distal end thereof into the hole.

15. The apparatus of claim 14, wherein the clamp further comprises:
a) a front clamp plate connected to the frame
b) a rear clamp plate movably connected to said frame;
c) first and second side clamp plates movably connected to said frame;
wherein said rear clamp plate is adapted for longitudinal sliding on the frame to clamp the brick in the longitudinal direction and the first and second side clamp plates are adapted for transverse sliding on the frame to clamp the brick in the transverse direction.

16. The apparatus of claim 15, further comprising a main carriage movably connected to the frame and adapted for longitudinal sliding movement, wherein the rod is connected to the main carriage.

17. The apparatus of claim 16, further comprising a pair of sliding rails, wherein the main carriage and the rear clamp plate slides on the pair of sliding rails.

18. The apparatus of claim 17, further comprising a pair of transverse rails, wherein the first and second side clamp assemblies are adapted to slide on the pair of transverse rails.

19. The apparatus of claim 18, wherein the pressurized fluid comprises pressurized air.

20. The apparatus of claim 19, further comprising a supply of pressurized air, the supply being in fluid communication with the tube.

21. The apparatus of claim 20, further comprising a plurality of the rods.
